(19) United States
(12) Patent Application Publication
(10) Pub. No.: US 2009/0294015 A1
(43) Pub. Date: Dec. 3, 2009

(54) Weather-resistant illuminated ornamental stepping stones and method of manufacture thereof

(76) Inventor: Larry Gluck, Thousand Oaks, CA (US)

Correspondence Address: SANDRA LEE LIPKIN A LAW CORPORATION, P.O.Box 3518, VENTURA, CA, 93006, US

(21) Appl. No.: 12/156,587

(22) Filed: Jun. 2, 2008

(51) Int. Cl. B32B 37/00

(52) U.S. Cl. 156/71

(57) ABSTRACT

A method for creating illuminated stepping stones that can include customized graphic art on the interior of the substantially dome-shaped lid of the stepping stone. The method involves the use of a print that is formed, die-cut and molded to the dimensions of the interior surface of the substantially dome-shaped lid. Optionally, a white flood backing can be added. Optionally, the image can extend down the cylindrical sidewall of the stepping stone. Optionally, a non-slip surface can be added to the top of the stone. Optionally, an inverted cup attached to a base can be included on the interior portion of the stepping stone to minimize deflection when pressure is applied when stepped upon. Optionally, an opaque ring can be placed on the interior portion of the cylindrical sidewall of the stepping stone to stop the leak of light through the side. The result is a weather-resistant, decorative illuminated stepping stone that is customizable.

### BACKGROUND OF THE INVENTION

1. Field of the Invention

The present invention relates generally to the field of stepping stones, and particularly to weather-resistant illuminated ornamental stepping stones and a method of manufacture of same.

2. Background and Description of the Prior Art

In commercial, residential, municipal and other types of landscaping, it is often desirable for the landscape to include stepping stones as a way of traveling through the area without harming grass, foliage or other ornamentation. Landscaping is an art form in which all elements added to the landscape are added with consideration of their appearance and overall aesthetic contributions to the overall experience of the area.

One way to add to the aesthetic experience of a landscape is to provide stepping stones that are illuminated, decorative or both. The use of illuminated stepping stones or pathway lights is not new. The inventor of the instant patent has patented his own illuminated stepping stones (U.S. Pat. No. 4,992,914). Likewise, the ornamentation of stepping stones is not new. Stepping stones with personalized family character engravings can be purchased at walmart.com. In the past, however, previous designs were unable to achieve a natural stone appearance or were constrained to a limited variety of surface painted finishes.

Previous systems and designs did not provide for a customizable look to the artwork found on stepping stones. There exists, therefore, a need to overcome the shortcomings of the prior art and provide illuminated stepping stones that are capable of providing any image desired by the designer or consumer and that is weather-resistant and durable.

### SUMMARY OF THE INVENTION

The instant invention comprises a method for creating a customized print on a weather-resistant, durable illuminated stepping stone, the stepping stone comprising a means for illumination, a cylindrical sidewall having an exterior surface and an interior surface and a substantially dome-shaped top having an exterior surface and an interior surface, the method comprising the steps of: obtaining a digital print of the desired image; forming the print to conform to the dimensions of the interior surface of the substantially dome-shaped top, creating a formed print; die-cutting the formed print to conform to the dimensions of the substantially dome-shaped top, creating a die-cut piece; placing the die-cut piece on the interior surface of the substantially dome-shaped top; and overmolding a resin on the die-cut piece creating an illuminated, decorative assembly.

The above embodiment can be further modified by defining that the formed print is created using a vacuum.

The above embodiment can be further modified by defining that the formed print is created using pressure.

The above embodiment can be further modified by defining that after the first step of obtaining a digital print of the desired image and before the step of forming the print to conform to the dimensions of the interior of the substantially dome-shaped top, the following step is inserted: pre-coating the interior surface of the substantially dome-shaped top with a white backing flood coat.

The above embodiment can be further modified by defining that after the final step of overmolding a resin on the die-cut piece, the following step is inserted: coating the exterior surface of the substantially dome-shaped top with a non-slip finish.

The above embodiment can be further modified by defining that the following step is inserted: inserting a light blocking ring on the interior surface of said cylindrical sidewall.

The above embodiment can be further modified by defining that the following step is inserted: connecting the assembly to a base and an anti-deflection assembly, the anti-deflection assembly further comprising: a clear inverted cup restrained in a retaining ring and attached to the base.

The above embodiment can be further modified by defining that the inverted cup is able to diffuse some light.

The above embodiment can be further modified by defining that when forming the print to conform to the dimensions of the interior surface of the substantially dome-shaped top, the print extends down the interior surface of the cylindrical sidewall.

### BRIEF DESCRIPTION OF THE DRAWINGS

For a better understanding of the present invention, reference is to be made to the accompanying drawings. It is to be understood that the present invention is not limited to the precise arrangement shown in the drawings.

FIG. 1 is a perspective view of the invention in use in a landscape, but without any prints on the illuminated stepping stones.

FIG. 2 is a top view of one of the stones with a space in phantom for the placement of an image.

FIG. 3 is a top view of one of the stones with a natural look.

FIG. 4 is a top view of one of the stones with directions on the stone to a pool and spa and an arrow.

FIG. 5 is a top view of one of the stones reading “Welcome” thereon.

FIG. 6 is a flow chart demonstrating the steps of creating the customized stepping stones.

FIG. 7 is a flow chart demonstrating the preferred embodiment with some optional extra steps.

FIG. 8 is a flow chart demonstrating an alternate embodiment of the method of the instant invention.

### DETAILED DESCRIPTION OF A PREFERRED EMBODIMENT

Turning to the drawings, the preferred embodiment is illustrated and described by reference characters that denote similar elements throughout the several views of the instant invention.

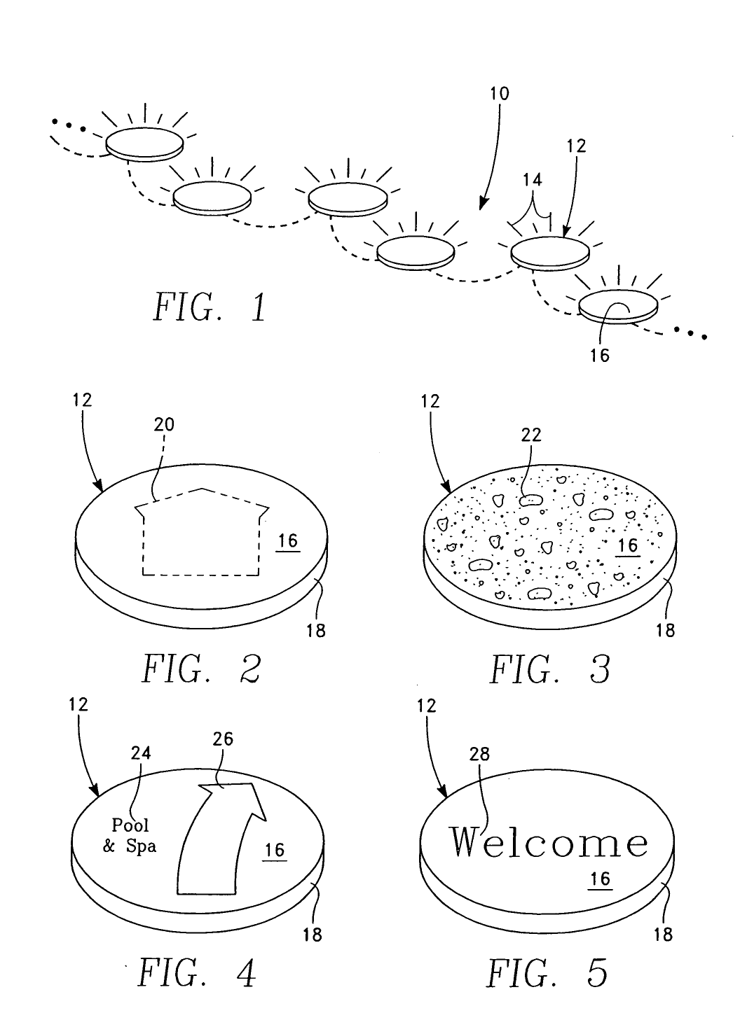

The preferred embodiment refers to a system for providing illuminated, ornamental, weather-resistant stepping stones in a landscaped area. As seen in FIG. 1, a path 10 of illuminated stones 12 is disclosed in the present invention. In FIG. 1, prior art of only illuminated stones 12 are shown, rather than showing stones 12 with art added to the top surface of the stones. Each of the stones 12 follows a path 10 that can be stepped upon by persons walking through the area. The illumination 14 allows for a dispersion of light and nice aesthetic effect as well as providing illumination at night. Each of the stones 12 has a substantially dome-shaped top 16.

FIGS. 2-5 show close-ups of samples of stones 12 with artwork included thereon using the method described in the instant invention. Each stone 12 has a cylindrical sidewall 18 and a substantially dome-shaped top 16. In FIG. 2, a blank space 20 is shown that can include any image desired by the landscaper. In FIG. 3, an example of a natural image 22 is illustrated. In FIG. 4, an example of a combination of words 24 and arrows 26 is illustrated that can provide directions to other portions of the landscaped area. In FIG. 5, an example is shown where one word “WELCOME” 28 is placed on the top 16 of the stone 12.

The initial system runs on any 12 volt transformer, which is commonly used in outdoor lighting. However, other voltages can be accommodated by modifying the lighting element. With the addition of a battery and a top surface solar cell, the features of this design may be incorporated in a stand-alone solar powered configuration. The lighting element in the hard-wired version may be a standard incandescent, halogen, xenon, LED or other lighting system. The lighting technology in the solar version is constrained to the LED system.

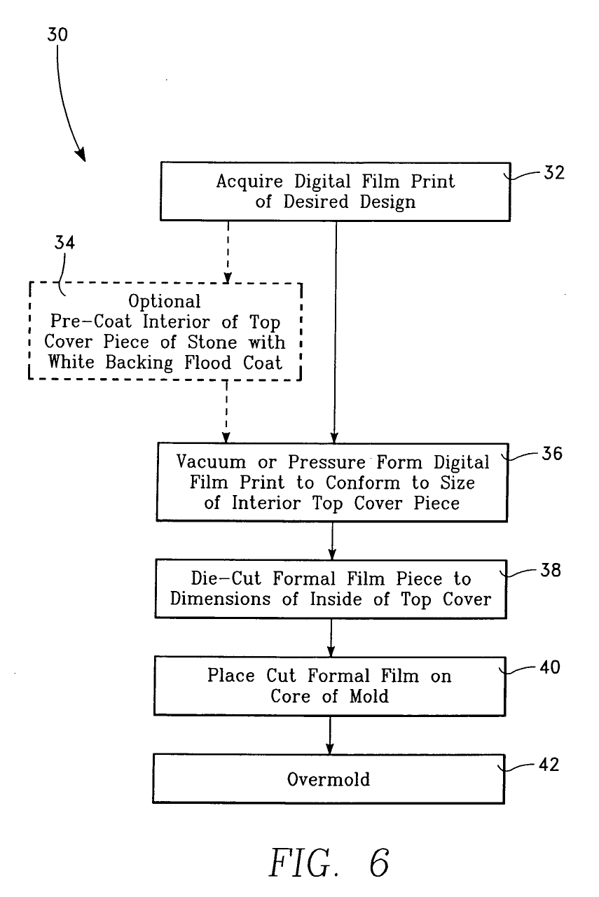

FIG. 6 is a flow-chart 30 that illustrates the basic fabrication method of the ornamental stones. First, a digital film print of a desired design is acquired 32. Before going to the mandatory second step, an optional step 34 is included that pre-coats the interior of the top cover piece of stone with a white backing flood coat. This creates a background on which the colors of the desired art can contrast and provides a degree of light diffusion which enhances the product appeal.

Third 36, the print is then vacuum or pressure formed to conform to the dimensions of the interior of the top cover piece. The formed film piece is then die-cut 38 to the dimensions of the inside of the top cover. The die-cut piece is the placed on the core of the mold 40 and then the overmold is applied 42.

The decorative finish is applied to a film typically having a thickness ranging from 0.007″ to 0.040″. The film is relatively clear. In the preferred embodiment, polycarbonate film is used, but other clear films will work, provided that the film is compatible with the molded resin with which the film is required to bond. The preferred embodiment includes a film that is digitally printed with solvent inks to enable bonding with the film stock. The pigments or dyes in the inks must also be UV-resistant, such as those used in outdoor signage or similar applications. The inks are deposited on the interior, or “second,” surface of the stone so that the inks are protected from both the heat and pressure of the molding process as well as the wear and tear of in-situ use.

The digital process allows for the creation of natural stone finishes, photographic images, company logos, etc. The content of the image is limited only by the imagination of the user. Some examples of art used include: stone finishes, such as marble, brick, used brick, slate, sand with seashells, fossil rock, travertine, and pebble; photo finishes, such as national parks, family members or houses; logos and graphics, such as corporate images of hotel chains, private golf course logos and restaurant chain logos; user-supplied, such as photos in the .jpg, raw, TIFF, psd or other digital format, and supplied photographs for digital scanning.

Once the film is digitally printed, the film is optionally flood coated with a white backing. This creates a background on which the colors of the selected image can contrast. This also provides a degree of light diffusion that enhances the product's appeal. After the flood coat, the film is vacuum or pressure formed to conform to the interior dimensions of the top cover piece. The formed film piece is then die cut so that it has the dimensions of the inside of the top cover.

The printed and die cut film piece is then placed on the core of the mold. It is then overmolded. It is important to note that the hot resin only contacts the non-printed side of the film piece. The digital inks cannot withstand the heat and pressure of the molding process. Further, the resin bonds perfectly with the film since they are compatible materials, thus eliminating any possibility of delamination in the future.

It is possible to achieve some of the finishing possibilities of the instant invention using surface silk screen inks. Some silk screen inks can withstand the molding process, but they will not achieve the flexibility or breadth of possibilities of digital printing.

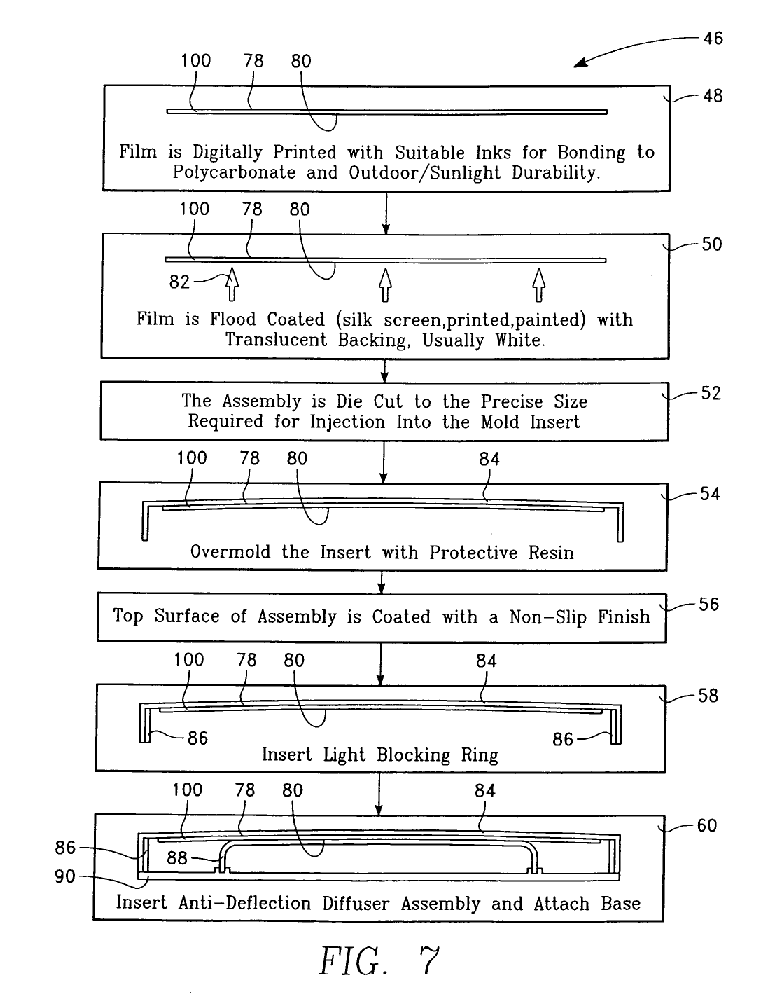

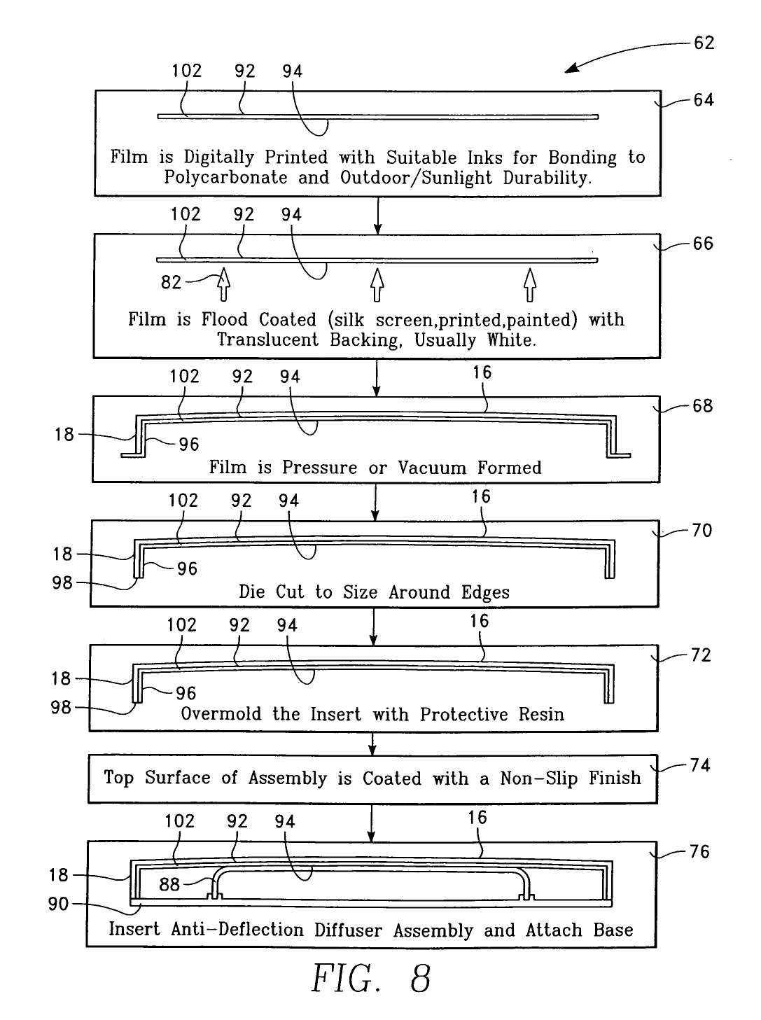

The preferred embodiment of the instant invention is described in detail below along with optional steps, as illustrated in FIG. 7, followed by an alternate embodiment as illustrated in FIG. 8.

### Method 1 (Preferred Embodiment) 46

Step 1: 48 Obtain a flat piece of polycarbonate film or sheet 100, with a thickness between 0.007″ and 0.040″. The top surface 78 of the film 100 remains clear, while the bottom surface 80 will contain the printed image. The film 100 is digitally printed with suitable inks chosen for their ability to bond to polycarbonate and their ability to withstand outdoor elements and sunlight. The film may also be dip coated or silk screened.

Step 2: 50 The film 100 can be flood coated 82 via silk screen, print or paint with a translucent backing that is usually white. This coating diffuses the backlighting and provides a background to enhance the digital printing contrast.

Step 3: 52 The entire assembly is die cut to the precise size required for injection into the mold insert.

Step 4: 54 The insert is overmolded so that the printed film 100 is on the inside of the substantially dome-shaped top of the stone. The molded resin 84 protects the printed art 80 by providing structural integrity, chemical resistance and additional uv-resistance.

Step 5: 56 The assembly is coated with a non-slip finish on the top surface.

Step 6: 58 A light blocking ring 86 is inserted on the interior portion of the cylindrical sidewall, thereby preventing the leaking of light through the sides of the stones and keeping the illumination diffusing only from the top of the stone where the print and diffuse flood coat are present.

Step 7: 60 The assembly is connected to a base 90 and a combination anti-deflection diffuser assembly 88. This step is provided because plastic/hollow assemblies are subject to significant deflection when pressure is applied through stepping. Support columns could be used to avoid this problem, but they cast shadows that are unattractive and interfere with the look of the stones. By including this assembly, a clear or semi-diffuse inverted cup that is restrained in a retaining ring in the base is incorporated. Thus, the stone resists deflection when pressure is applied through stepping.

### Method 2 (Alternate Embodiment) 62

Step 1: 64 Obtain a flat piece of polycarbonate film or sheet 102, with a thickness between 0.007″ and 0.040″. The top surface 92 of the film 102 remains clear, while the bottom surface 94 will contain the printed image. The film 102 is digitally printed with suitable inks chosen for their ability to bond to polycarbonate and their ability to withstand outdoor elements and sunlight. The film 102 may also be dip coated or silk screened.

Step 2: 66 The same as Step 2 in Method 1.

Step 3: 68 The film 102 is pressure or vacuum formed wherein the printed pattern 94 extends down the sides 96 of the dome-shopped top 16 and onto the cylindrical sidewalls 18.

Step 4: 70 The die is cut to size around the bottom edges 98 of the cylindrical sidewall 18.

Step 5: 72 The insert is overmolded as in Method 1.

Step 6: 74 The assembly is coated with a non-slip finish on the top surface.

Step 7: 76 Connected to the base as in Step 7 of Method 1.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. A method for creating a customized print on a weather-resistant, durable illuminated stepping stone, said stepping stone comprising a means for illumination, a cylindrical sidewall having an exterior surface and an interior surface and a substantially dome-shaped top having an exterior surface and an interior surface, said method comprising the steps of:
obtaining a digital print of the desired image;
forming said print to conform to the dimensions of said interior surface of said substantially dome-shaped top, creating a formed print;
die-cutting said formed print to conform to the dimensions of said substantially dome-shaped top, creating a die-cut piece;
placing said die-cut piece on said interior surface of said substantially dome-shaped top; and
overmolding a resin on said die-cut piece creating an illuminated, decorative assembly.

2. The method as defined in claim 1 wherein said formed print is created using a vacuum.

3. The method as defined in claim 1 wherein said formed print is created using pressure.

4. The method as defined in claim 1 wherein after the first step of obtaining a digital print of the desired image and before the step of forming said print to conform to the dimensions of said interior surface of said substantially dome-shaped top, the following step is inserted:
pre-coating said interior surface of said substantially dome-shaped top with a white backing flood coat.

5. The method as defined in claim 1 wherein after the final step of overmolding a resin on said die-cut piece, the following step is inserted:
coating said exterior surface of said substantially dome-shaped top with a non-slip finish.

6. The method as defined in claim 1 wherein the following step is inserted:
inserting a light blocking ring on said interior surface of said cylindrical sidewall.

7. The method as defined in claim 1 wherein the following step is inserted:
connecting said assembly to a base and an anti-deflection assembly, said anti-deflection assembly further comprising:
a clear inverted cup restrained in a retaining ring and attached to said base.

8. The method as defined in claim 7 wherein said inverted cup is able to diffuse some light.

9. The method as defined in claim 1 wherein when forming said print to conform to the dimensions of said interior surface of said substantially dome-shaped top, said print extends down said interior surface of said cylindrical sidewall.
